(19) United States
(12) Patent Application Publication
(10) Pub. No.: US 2024/0073684 A1
(43) Pub. Date: Feb. 29, 2024

(54) ELECTRONIC DEVICE FOR PROVIDING BIDIRECTIONAL KEY AGREEMENT PROTOCOL AND OPERATING METHOD THEREOF

(71) Applicant: AGENCY FOR DEFENSE DEVELOPMENT, Daejeon (KR)

(72) Inventors: Ik Rae JEONG, Seoul (KR); Jin Wook BYUN, Pyeongtaek-si (KR); Jae Yeol JEONG, Seoul (KR); Jae Hyun CHOI, Seoul (KR)

(21) Appl. No.: 18/205,162

(22) Filed: Jun. 2, 2023

(30) Foreign Application Priority Data
Aug. 23, 2022 (KR) 10-2022-0105656

(51) Int. Cl. H04W 12/06; H04W 12/02; H04W 12/0431

(52) U.S. Cl. CPC H04W 12/06; H04W 12/02; H04W 12/0431

(57) ABSTRACT

The present disclosure relates to a method of operating an electronic device that provides a key agreement protocol. Specifically, the method may include obtaining at least one of an ID of a user, a first anonymous ID of the user corresponding to the ID of the user and a first temporary authentication value of the user, from a user terminal, obtaining at least one of an ID of an unmanned aerial vehicle (UAV), a first anonymous ID of the UAV corresponding to the ID of the UAV and a first temporary authentication value of the UAV, from the UAV, and in response to a key agreement request of the user terminal or a key agreement request of the UAV, intermediating key agreement between the UAV and the user terminal based on first information including information obtained from the user terminal and second information including information obtained from the UAV.

### PRIORITY APPLICATION

This application claims the benefit of Korean Patent Application No. 10-2022-0105656, filed on Aug. 23, 2022, in the Korean Intellectual Property Office, the disclosure of which is incorporated herein by reference in its entirety.

### FIELD OF THE INVENTION

The example embodiments relate to an electronic device for providing one or more protocols that enable not only a user but also an unmanned aerial vehicle to request a key agreement first while satisfying forward unlinkability between the user and the unmanned aerial vehicle in the Internet of drones (IoD) environment, and a method operating the same.

### DISCUSSION OF THE RELATED ART

An unmanned aerial vehicle (UAV) (e.g., a drone) is a powered vehicle that can be operated remotely or automatically by using a GPS device without a pilot on board, and the scope of use is expanding not only for military purposes, but also in various fields such as video shooting, delivery service, pesticide spraying, intelligent traffic management, and 3D map information acquisition. Such a UAV may be connected to a terminal of a user (e.g., a manager) in a bidirectional communication method to transmit/receive predetermined information or commands.

In the IoD environment, the key agreement protocol is to exchange a key that allows a user and a UAV to communicate with each other through a server, and in this process, if information of the user and the drone is exposed, privacy may be infringed. Therefore, there is effort with regard to existing key agreement protocols to protect the privacy of the user by generating an anonymous ID to replace the user's ID. However, even if an anonymous ID is used, if the anonymous ID is exposed, there is a concern that the actual user can be traced based on the time and a place where the anonymous ID was used.

Further, when a UAV flying in the air first detects an accident, the UAV should be able to deliver relevant information to a user first, but only the user can make a request first, so there is a problem that a UAV cannot make a request even if the accident was discovered.

### SUMMARY OF THE INVENTION

Accordingly, the present invention is directed to an electronic device for providing bidirectional key agreement protocol and operating method thereof that substantially obviates one or more problems due to limitations and disadvantages of the related art.

An aspect provides a technology to provide a protocol that allows not only a user but also a UAV to make a key agreement request first, while satisfying forward unlinkability between the user and the UAV in the IoD environment. The technical tasks to be achieved by the present disclosure are not limited to the technical tasks described above, and other technical tasks may be inferred from following example embodiments.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

According to an aspect, there is provided a method of operating an electronic device, including obtaining at least one of an ID of a user, a first anonymous ID of the user corresponding to the ID of the user and a first temporary authentication value of the user, from a user terminal, obtaining at least one of an ID of an unmanned aerial vehicle (UAV), a first anonymous ID of the UAV corresponding to the ID of the UAV and a first temporary authentication value of the UAV, from the UAV, and in response to a key agreement request of the user terminal or a key agreement request of the UAV, intermediating key agreement between the UAV and the user terminal based on first information including information obtained from the user terminal and second information including information obtained from the UAV.

According to an example embodiment, the key agreement request of the UAV may correspond to transmitting the first anonymous ID of the UAV from the UAV to the user terminal, and the key agreement request of the user terminal may correspond to transmitting the first anonymous ID of the user terminal from the user terminal to the UAV.

According to an example embodiment, the intermediating key agreement between the UAV and the user terminal, in response to the key agreement request of the user terminal or the key agreement request of the UAV, may include sharing a same message authentication code (MAC) key and a same session key between the user terminal and the UAV, based on the first information and the second information.

According to an example embodiment, the first anonymous ID of the user and the first temporary authentication value of the user may be randomly generated regardless of the ID of the user.

According to an example embodiment, the first information may include at least one of the ID of the user, the first anonymous ID of the user, the first temporary authentication value of the user, a second anonymous ID different from the first anonymous ID of the user, a second temporary authentication value different from the first temporary authentication value of the user and a random number value of the user.

According to an example embodiment, the first anonymous ID of the UAV and the first temporary authentication value of the UAV may be randomly generated regardless of the ID of the UAV.

According to an example embodiment, the second information may include at least one of the ID of the UAV, the first anonymous ID of the UAV, the first temporary authentication value of the UAV, a second anonymous ID different from the first anonymous ID of the UAV, a second temporary authentication value different from the first temporary authentication value of the UAV and a random number value of the UAV.

According to an aspect, there is provided a method of operating a user terminal, including from a UAV requesting key agreement, obtaining a first anonymous ID of the UAV corresponding an ID of the UAV, identifying at least one of an ID of a user that is input from the user, a first anonymous ID of the user corresponding to the ID of the user, and a first temporary authentication value of the user, generating an encryption key and a first MAC key by using the first temporary authentication value, generating a second anonymous ID different from the first anonymous ID of the user and a second temporary authentication value different from the first temporary authentication value of the user, and generating a same second MAC key and a same session key shared between the user terminal and the UAV based on at least one piece of information related to the user and at least one piece of information related to the UAV.

According to an aspect, there is provided a method of operating a UAV, including obtaining a first anonymous ID of a user terminal corresponding to an ID of the user terminal from the user terminal requesting key agreement, identifying at least one of an ID of the UAV, a first anonymous ID of the UAV corresponding to the ID of the UAV, and a first temporary authentication value of the UAV, generating an encryption key and a first MAC key using the first temporary authentication value, generating a second anonymous ID different from the first anonymous ID of the UAV and a second temporary authentication value different from the first temporary authentication value of the UAV, and generating a same second MAC key and a same session key shared between the user terminal and the UAV based on at least one piece of information related to the user terminal and at least one piece of information related to the UAV.

According to an aspect, there is provided an electronic device, including a communication device, a memory for storing at least one instruction, and a controller that is configured to obtain at least one of an ID of a user, a first anonymous ID of the user corresponding to the ID of the user and a first temporary authentication value of the user, from a user terminal, obtain at least one of an ID of an unmanned aerial vehicle (UAV), a first anonymous ID of the UAV corresponding to the ID of the UAV and a first temporary authentication value of the UAV, from the UAV, and in response to a key agreement request of the user terminal or a key agreement request of the UAV, intermediate key agreement between the UAV and the user terminal based on first information including information obtained from the user terminal and second information including information obtained from the UAV.

Additional aspects of example embodiments will be set forth in part in the description that follows and, in part, will be apparent from the description, or may be learned by practice of the disclosure.

According to example embodiments, when performing key agreement protocol in the IoD environment, it is possible to guarantee strong anonymity that protects not only a user ID but also an anonymous ID from being exposed. Further, if a UAV is hijacked or a user's device is lost, even if the user or the UAV's secret key is exposed, past anonymous IDs cannot be known, so the forward unlinkability between the UAV and the user may be satisfied. Further, if an anonymous ID is generated every time, there is no relation between generated anonymous IDs, so the forward unlinkability between the UAV and the user may be satisfied. Further, even if an anonymous ID is exposed, the real user cannot be traced through the time and a place where the anonymous ID is used, so the forward unlinkability between the UAV and the user may be satisfied. In addition, not only the user but also the drone can make a key agreement request first, so that the occurrence of an incident or accident may be quickly dealt with.

The effect of the example embodiments are not limited to the above-described effects, and other effects not described would be clearly understood by those skilled in the art from the description of the claims.

It is to be understood that both the foregoing general description and the following detailed description are examples and explanatory and are intended to provide further explanation of the invention as claimed.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram of a system for providing a key agreement protocol according to an example embodiment;

FIG. 2 is a diagram for describing a process of registering a user in a server according to an example embodiment;

FIG. 3 is a diagram for explaining a process of registering a UAV in a server according to an example embodiment;

FIGS. 4A and 4B are diagrams for explaining a key agreement procedure between a user terminal and a UAV at a request of the UAV according to an example embodiment;

FIGS. 5A and 5B are diagrams for explaining a key agreement procedure between a user terminal and a UAV at a request from the user terminal according to an example embodiment;

FIG. 6 is a flowchart illustrating a method of operating an electronic device according to an example embodiment;

FIG. 7 is a flowchart illustrating a method of operating a user terminal according to an example embodiment;

FIG. 8 is a flowchart illustrating a method of operating a UAV according to an example embodiment; and

FIG. 9 is a block diagram of an electronic device according to an example embodiment.

### DETAILED DESCRIPTION

Reference will now be made in detail to the embodiments of the present invention, examples of which are illustrated in the accompanying drawings.

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Expression “at least one of a, b and c” described throughout the specification may include “a alone,” “b alone,” “c alone,” “a and b,” “a and c,” “b and c” or “all of a, b and c.”

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments of the present disclosure will be described in detail with reference to the accompanying drawings.

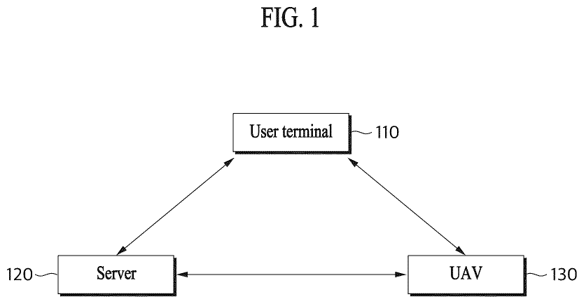

FIG. 1 is a block diagram of a system for providing a key agreement protocol according to an example embodiment.

According to various example embodiments, a system in the IoD environment that provides a bidirectional key agreement protocol may include a server 120 supporting a key agreement protocol for bidirectional communication between a user terminal 110 and a UAV 130.

The server 120 may perform various control functions related to a key agreement protocol between the user terminal 110 and the UAV 130. The key agreement protocol may indicate having security during communication with a method in which, in general, two entities (e.g., the user terminal 110 and the UAV 130) exchange a symmetric key and encrypt a message by using the corresponding key. Further, the key agreement protocol in the IoD environment may indicate exchanging a key that allows the user terminal 110 and the UAV 130 to communicate with each other through the server 120.

In various example embodiments, the server 120 may use at least one of a symmetric key encryption system, a public key encryption system, a hash function, a message authentication code (MAC), and fuzzy extraction using biometric information. For example, the server 120 may provide a user with strong anonymity and forward unlinkability by using a symmetric key, a hash function and a MAC instead of using the existing hash function and XOR operation.

The user terminal 110 is a device that has mobility and includes a predetermined communication module. For example, the user terminal 110 may correspond to any one of a mobile phone, a smartphone, a portable console, a navigation system, a laptop computer and a tablet. The user terminal 110 may be referred to as a user equipment (UE), a mobile station, a terminal, a station (STA), a user device, a portable electronic device, or the like. In another example embodiment, the user terminal 110 may correspond to a device having a fixed location.

The user terminal 110 may be a device for transmitting a control command to the UAV 130 or receiving predetermined information (e.g., image information) from the UAV 130. The control command may correspond, for example, information for controlling the operation or mobility of the UAV 130.

The UAV 130 may be a device that performs a designated function while a pilot is not on board, and may correspond to a UAV having mobility. For example, the UAV 130 may fly while changing the direction or the altitude in order to perform a designated function. For example, the UAV 130 may fly under the control of the communication-connected server 120 or the user terminal 110 and selectively collect predetermined information. Alternatively, the UAV 130 may autonomously fly, obtain image information, detect whether there is a danger based on the relevant information, and provide the relevant information to the server 120 or the user terminal 110 in the adjacent location.

Hereinafter, operations between the user terminal 110, the server 120 and the UAV 130 will be described in detail.

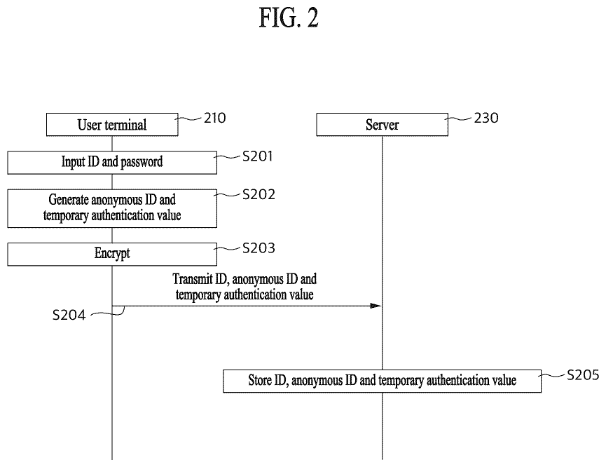

FIG. 2 is a diagram for describing a process of registering a user in a server according to an example embodiment.

Referring to FIG. 2, a user terminal 210 may be, for example, a smartphone as a device used by the user. In operation S201, the user may input ID Uᵢ and password pwᵢ into the user terminal 210. In operation S202, the user terminal 210 may randomly generate anonymous ID PUᵢ and temporary authentication value αᵢ.

In operation S203, the user terminal 210 may encrypt (vᵢ) the generated anonymous ID and temporary authentication value corresponding to Equation 1 below by using the hashed values of the ID and the password as keys, and store the generated anonymous ID and temporary authentication value. Specifically, a hash function operation may be performed by using a preset hash algorithm (e.g., SHA256, and SHA512) to concatenate ID Uᵢ and password pwᵢ as an input value, a secret value (key) of a symmetric key encryption such as advanced encryption standard (AES) and academy research institute agency (ARIA) may be generated based on the operation result, and using this, anonymous ID PUᵢ and temporary authentication value αᵢ may be encrypted. The same procedure may be applied with respect to E_{H} indicated in many of equations described herein.

vᵢ=E_{H(U}_{ᵢ}_{∥pw}_{ᵢ}₎(PUᵢ∥αᵢ) [Equation 1]

In operation S204, the user terminal 210 may transmit the ID, the generated anonymous ID and the temporary authentication value to a server 230. In operation S205, the server 230 may store the ID, the anonymous ID and the temporary authentication value of the user in the database. In this case, the server 230 may store the received anonymous ID in a past anonymous ID and a current anonymous ID, and the server 230 may store the received temporary authentication value in a past authentication value and a current authentication value. For example, the server 230 may store received anonymous ID 1 in past anonymous ID 1 and current anonymous ID 1. Thereafter, when the anonymous ID is updated to anonymous ID 2, the server 230 may update the current anonymous ID to anonymous ID 2 and store the past anonymous ID as anonymous ID 1.

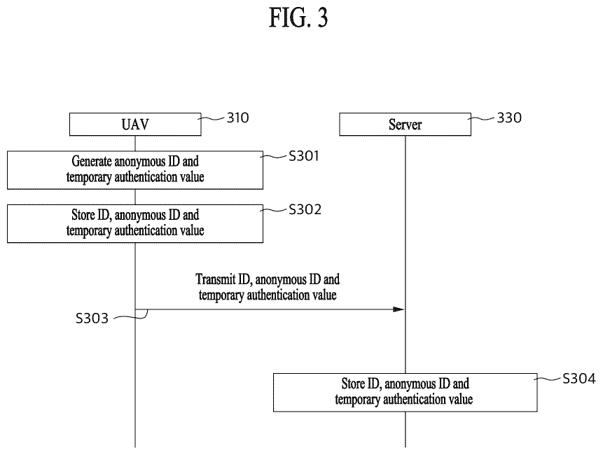

FIG. 3 is a diagram for explaining a process of registering a UAV in a server according to an example embodiment.

Referring to FIG. 3, a UAV 310 may include, for example, a device such as a drone. In operation S301, the UAV 310 may randomly generate anonymous ID PDᵢ and temporary authentication value βⱼ. In operation S302, the UAV 310 may store ID Dᵢ, an anonymous ID and a temporary authentication value of the UAV. In operation S303, the UAV 310 may transmit the ID, the anonymous ID and the temporary authentication value of the UAV to a server 330.

In operation S304, the server 330 may store the received ID, the anonymous ID and the temporary authentication value of the UAV. In this case, the server 330 may store the received anonymous ID in the past anonymous ID and the current anonymous ID, and may store the received temporary authentication value in the past authentication value and the current authentication value. For example, the server 330 may store received anonymous ID 1 as past anonymous ID 1 and current anonymous ID 1. Thereafter, if the anonymous ID is updated to anonymous ID 2, the server 330 may update the current anonymous ID to anonymous ID 2 and store the past anonymous ID as anonymous ID 1.

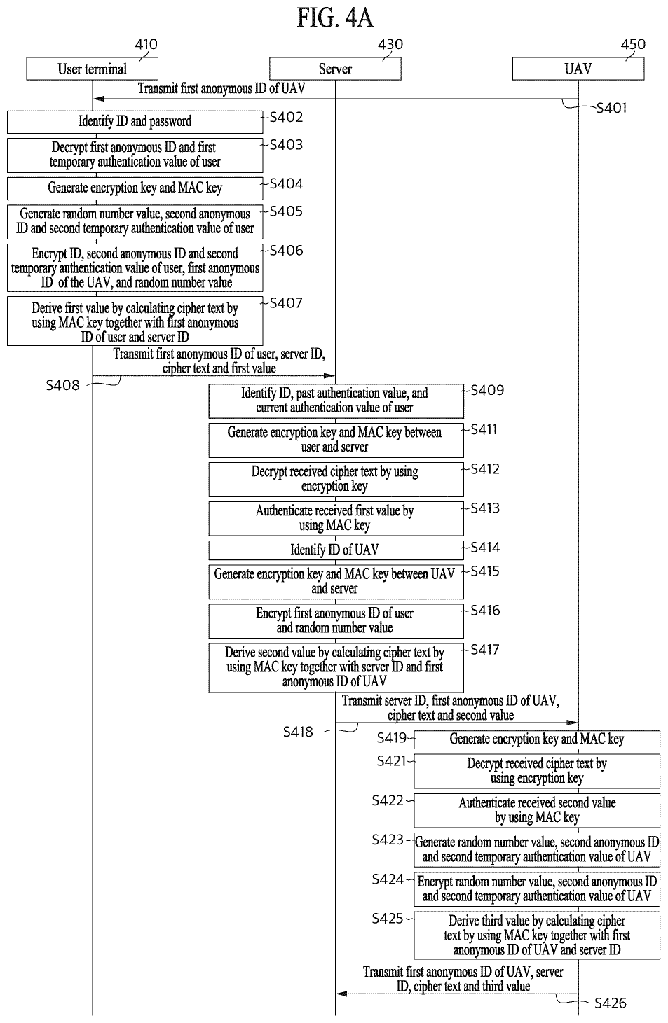

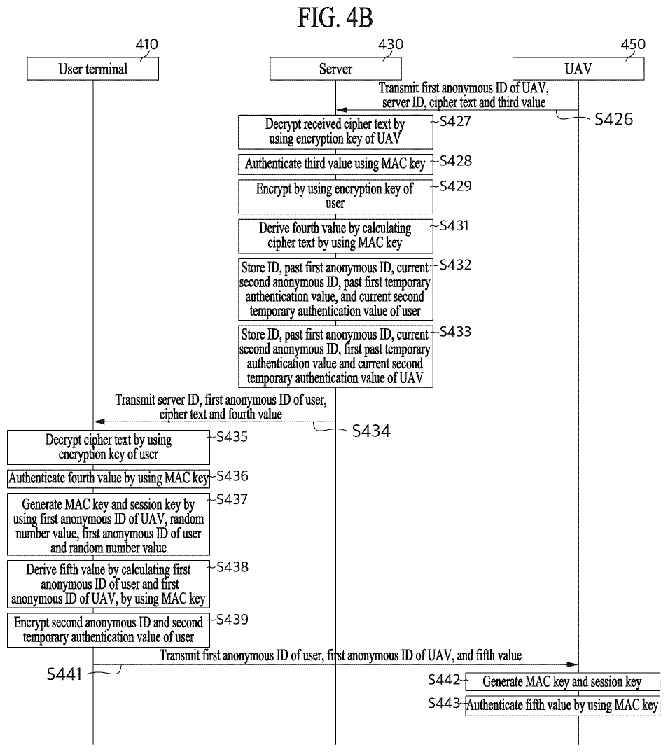

FIGS. 4A and 4B are diagrams for explaining a key agreement procedure between a user terminal and a UAV at a request of the UAV according to an example embodiment. In FIGS. 4A and 4B, a server 430 may store and register information about a user terminal 410 and a UAV 450 according to FIGS. 2 and 3.

In operation S401, the UAV 450 may transmit first anonymous ID PDᵢ of the UAV to the user terminal 410.

In operation S402, the user terminal 410 may identify ID Uᵢ and password pwᵢ input by the user. In operation S403, the user terminal 410 may decrypt (D_{H}) the user's first anonymous ID and the first temporary authentication value based on Equation 2 using the identified information.

PUᵢ∥αᵢ=D_{H(U}_{ᵢ}_{∥pw}_{ⱼ}₎(vᵢ) [Equation 2]

In operation S404, the user terminal 410 may generate encryption key ekᵢ based on below Equation 3 by using the temporary authentication value, and may generate MAC key mkᵢ based on below Equation 4. Specifically, by using a preset hash algorithm (e.g., SHA256), encryption key ekᵢ may be generated by using a value obtained by concatenating temporary authentication value αᵢ and 0 as an input value. Alternatively, by using a preset hash algorithm (e.g., SHA256), MAC key mkᵢ may be generated by using a value obtained by concatenating temporary authentication value αᵢ and 1 as an input value. The same procedures may be applied with respect to ekᵢ and mkᵢ indicated in many of equations described herein.

ekᵢ=H(αᵢ∥0) [Equation 3]

mkᵢ=H(αᵢ∥1) [Equation 4]

In operation S405, the user terminal 410 may generate random number value ruᵢ, new second anonymous ID PUᵢ′ different from the first anonymous ID, and new second temporary authentication value αᵢ′ different from the first temporary authentication value.

In operation S406, the user terminal 410 encrypts the ID, the newly generated second anonymous ID, the newly generated second temporary authentication value, the first anonymous ID of the UAV, and the random number value, by using the encryption key based on Equation 5 below. Specifically, by using ekᵢ generated through Equation 3 as a secret value (i.e., an encryption key and a decryption key), an ID, a newly generated second anonymous ID, a newly generated second temporary authentication value, a first anonymous ID of the UAV, and a random number value may be encrypted with a symmetric key. The same procedures may be applied with respect to Eₑₖ_{ᵢ} indicated in many of equations described herein.

cᵢ=Eₑₖ_{ᵢ}(Uᵢ∥PUᵢ′∥αᵢ′∥PDⱼ∥ruᵢ) [Equation 5]

In operation S407, the user terminal 410 may derive first value τᵢ by calculating cipher text cᵢ based on Equation 6 below by using MAC key mkᵢ together with the user's first anonymous ID and the server ID. Specifically, authentication value τᵢ may be generated by using MAC key mkᵢ generated through Equation 4 along with cipher text cᵢ, the user's firsts anonymous ID and the server ID. Thereafter, using the MAC key, whether authentication value τᵢ is a legitimate message may be authenticated. The same procedure may be applied with respect to operation using the MAC key indicated in many of equations described herein.

τᵢ=Macₘₖ_{ᵢ}(PUᵢ∥S∥cᵢ) [Equation 6]

In operation S408, the user terminal 410 may transmit the user's first anonymous ID, the server ID, the cipher text and the first value to the server 430.

In operation S409, the server 430 may identify the user's ID, the past authentication value, and the current authentication value by using the user's first anonymous ID. In operation S411, the server 430 may generate an encryption key between the user and the server using the current authentication value or the past authentication value based on Equation 7 below, or may generate a MAC key based on Equation 8 below. The contents described in relation to Equation 3 and Equation 4 may be applied.

ekᵢ=H(αᵢ∥0) [Equation 7]

mkᵢ=H(αᵢ∥1) [Equation 8]

In operation S412, the server 430 may decrypt the received cipher text with the encryption key. In operation S413, the server 430 may authenticate the received first value using the MAC key. In operation S414, when the first value is authenticated, the server 430 may identify the ID, the past authentication value, and the current authentication value of the UAV by using the decrypted anonymous ID of the UAV. In operation S415, the server 430 may generate an encryption key between the UAV and the server based on Equation 9 by using the identified past authentication value or the current authentication value, and may generate a MAC key based on Equation 10. The contents described in relation to Equation 3 and Equation 4 may be applied.

ekⱼ=H(βⱼ∥0) [Equation 9]

mkⱼ=H(βⱼ∥1) [Equation 10]

In operation S416, the server 430 may encrypt the user's first anonymous PUᵢ and user-generated random number value ruᵢ with the generated encryption key based on Equation 11. The contents described in relation to Equation 5 may be applied.

cⱼ=Eₑₖ_{ⱼ}(PUᵢ∥ruᵢ) [Equation 11]

In operation S417, the server 430 may derive a second value by calculating cipher text cⱼ based on Equation 12 by using the MAC key together with the server ID and the first anonymous ID of the drone. The contents described in relation to Equation 6 may be applied.

τⱼ=Macₘₖ_{ⱼ}(S∥PDⱼ∥cⱼ) [Equation 12]

In operation S418, the server 430 may transmit server ID S, the drone's first anonymous ID PDⱼ, cipher text cⱼ and second value τⱼ to the UAV 450.

In operation S419, the UAV 450 may generate an encryption key based on Equation 13 by using the authentication value of the UAV, and may generate a MAC key based on Equation 14. The contents described in relation to Equation 3 and Equation 4 may be applied.

ekⱼ=H(βⱼ∥0) [Equation 13]

mkⱼ=H(βⱼ∥1) [Equation 14]

In operation S421, the UAV 450 may decrypt the cipher text received from the server 430 using the generated encryption key. In operation S422, the UAV 450 may authenticate the received second value using the MAC key. In operation S423, the UAV 450 may generate a random number value, a new second anonymous ID and a new second temporary authentication value. In operation S424, the UAV 450 may encrypt generated second anonymous ID PDⱼ′, second temporary authentication value βⱼ′, random number value rdⱼ and random number value ruᵢ generated by the user terminal 410, based on Equation 15. The contents described in relation to Equation 5 may be applied.

dⱼ=Eₑₖ_{ⱼ}(PDⱼ′∥βⱼ′∥ruⱼ∥rdⱼ) [Equation 15]

In operation S425, the UAV 450 may derive a third value by calculating generated cipher text dⱼ based on Equation 16 by using the MAC key together with first anonymous ID PDⱼ of the drone and ID S of the server. The contents described in relation to Equation 6 may be applied.

∈ⱼ=Macₘₖ_{ⱼ}(PDⱼ∥S∥dⱼ) [Equation 16]

In operation S426, the UAV 450 may transmit the drone's first anonymous ID PDⱼ, server ID S, cipher text dⱼ and third value ∈ⱼ to the server 430.

In operation S427, the server 430 may decrypt the received cipher text using the encryption key of the UAV. In operation S428, the server 430 may authenticate the third value using the MAC key. In operation S429, the server 430 may operate encryption based on Equation 17 using the user's encryption key ekᵢ. The contents described in relation to Equation 5 may be applied.

dᵢ=Eₑₖ_{ᵢ}(PDⱼ∥ruᵢ∥rdⱼ) [Equation 17]

In operation S431, the server 430 may derive fourth value ∈ⱼ by calculating cipher text dᵢ based on Equation 18 by using the MAC key. The contents described in relation to Equation 6 may be applied.

∈_{f}=Macₘₖ_{ⱼ}(S∥PUᵢ∥dᵢ) [Equation 18]

In operation S432, the server 430 may store the user's ID Uᵢ, the user's past first anonymous ID PUᵢ, the user's current second anonymous ID PUᵢ′, the user's past first temporary authentication value αᵢ, and the user's current second temporary authentication value αᵢ′, as in Equation 19.

Uᵢ,PUᵢ^{o}=PUᵢ,PUₗ^{m}=PU_{i′},αᵢ^{o}=αᵢ,αᵢⁿ=α_{i′} [Equation 19]

In operation S433, the server 430 may store ID Dⱼ of the UAV, past first anonymous ID PDⱼ of the UAV, current second anonymous ID PDᵢ′ of the UAV, first past temporary authentication value βⱼ of the UAV and current second temporary authentication value βⱼ′ of the UAV, as in Equation 20.

Dⱼ,PDⱼ^{o}=PDⱼ,PDⱼⁿ=PDⱼ′,βⱼ^{o}=βⱼ,βⱼⁿ=βⱼ′ [Equation 20]

In operation S434, the server 430 may transmit the ID of the server, the first anonymous ID of the user, the cipher text and the fourth value to the user terminal 410.

In operation S435, the user terminal 410 may decrypt the received cipher text using the user's encryption key. In operation S436, the user terminal 410 may authenticate the received fourth value using the MAC key.

In operation S437, the user terminal 410 may generate a MAC key based on Equation 21 by using first anonymous ID PUᵢ and random number value ruᵢ of the user, and first anonymous ID PDᵢ and random number value rdⱼ of the UAV, and the user terminal 410 may generate a session key based on Equation 22. The contents described in relation to Equation 3 and Equation 4 may be applied.

mk_{i,j}=H(PUᵢ∥PDⱼ∥ruᵢ∥rdⱼ∥0) [Equation 21]

sk_{i,j}=H(PUᵢ∥PDⱼ∥ruᵢ∥rdⱼ∥1) [Equation 22]

In operation S438, the user terminal 410 may derive fifth value δ_{i,j} by calculating the user's first anonymous ID PUᵢ and the drone's first anonymous ID PDⱼ based on Equation 23 by using the MAC key. The contents described in relation to Equation 6 may be applied.

δ_{i,j}=Macₘₖ_{_{i,j}}(PUᵢ∥PDⱼ∥0) [Equation 23]

In operation S439, the user terminal 410 may encrypt the user's second anonymous ID PUᵢ′ and second temporary authentication value αᵢ′ based on Equation 24 and then store. The contents described in relation to Equation 1 may be applied.

$$\text{?} = \text{?} ( P \text{?} ‖ \text{?} ) \qquad [ Equation 24 ]$$

$$\text{?} \text{indicates text missing or illegible when filed}$$

In operation S441, the user terminal 410 may transmit the first anonymous ID of the user, the first anonymous ID of the drone and the fifth value to the UAV 450.

In operation S442, the UAV 450 may generate a MAC key based on Equation 25 by using anonymous IDs and random number values, and may generate a session key based on Equation 26. In this case, the MAC key and the session key generated based on Equation 25 and Equation 26 may be the same as the MAC key and the session key generated based on Equation 21 and Equation 22. Therefore, the user terminal and the UAV may share the same MAC key and the same session key. The contents described in relation to Equation 3 and Equation 4 may be applied.

mk_{i,j}=H(PUᵢ∥PDⱼ∥ruᵢ∥rdⱼ∥0) [Equation 25]

sk_{i,j}=H(PUᵢ∥PDⱼ∥ruᵢ∥rdⱼ∥1) [Equation 26]

In operation S443, the UAV 450 may authenticate the fifth value received from the user terminal. Thereafter, the UAV 450 may store an ID of the UAV, current second anonymous ID PDᵢ′ of the UAV and current second temporary authentication value βᵢ′.

According to the request of the UAV, the key agreement protocol may be performed through operations of FIGS. 2, 3, 4A and 4B described above.

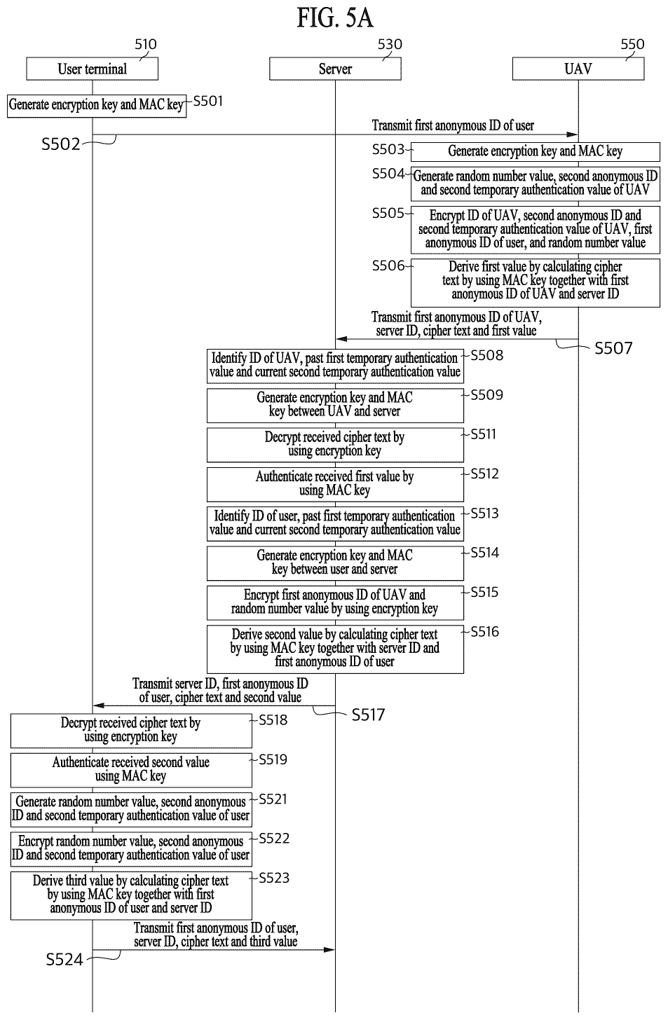

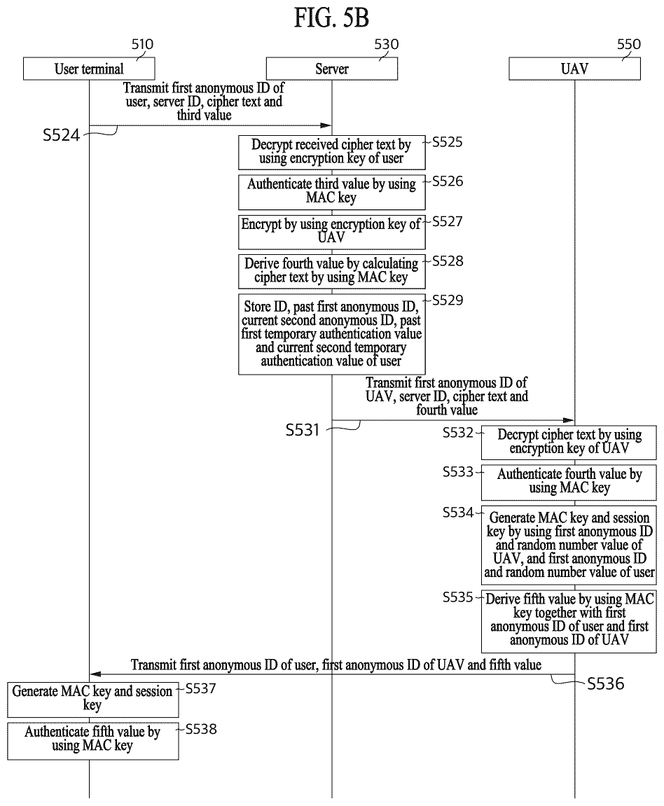

FIGS. 5A and 5B are diagrams for explaining a key agreement procedure between a user terminal and a UAV at a request from the user terminal according to an example embodiment. In FIGS. 5A and 5B, a server 530 may store and register information about a user terminal 510 and a UAV 550 according to FIGS. 2 and 3.

Unlike the sequence of the UAV, the user terminal, the server, the UAV, the server, the user terminal and the UAV in FIGS. 4A and 4B, referring to FIGS. 5A and 5B, a sequence of the user terminal, the UAV, the server, the user terminal, the server, the UAV and the user terminal may proceed. The descriptions with regard to FIGS. 4A and 4B and descriptions with regard to FIGS. 5A and 5B may have the same meaning.

The contents described in the equations of FIGS. 4A and 4B may also be applied to the process of calculating the equations of FIGS. 5A and 5B.

In operation S501, the user terminal 510 may decrypt an anonymous ID and an authentication value by using a user's ID and password, and may generate an encryption key and a MAC key. In operation S502, the user terminal 510 may transmit the user's first anonymous ID to the UAV 550.

In operation S503, the UAV 550 may generate an encryption key based on Equation 27 by using first temporary authentication value βⱼ, and may generate a MAC key based on Equation 28.

ekⱼ=H(βⱼ∥0) [Equation 27]

mkⱼ=H(βⱼ∥1) [Equation 28]

In operation S504, the UAV 550 may generate random number value rdⱼ, new second anonymous ID PDⱼ′ and second temporary authentication value βᵢ′. In operation S505, the UAV 550 may encrypt ID Dⱼ of the UAV, second temporary authentication value PDⱼ′, second temporary authentication value βⱼ′, the users first anonymous ID PUᵢ and random number value rdⱼ, based on Equation 29.

cⱼ=Eₑₖ_{ⱼ}(Dⱼ∥PDⱼ′∥βⱼ′∥PUᵢ∥rdⱼ) [Equation 29]

In operation S506, the UAV 550 may derive first value rⱼ by calculating cipher text eⱼ based on Equation 30 by using MAC key mkⱼ together with first anonymous ID PDⱼ of the UAV and ID S of the server.

rⱼ=Macₘₖ_{ⱼ}(PDⱼ∥S∥cⱼ) [Equation 30]

In operation S507, the UAV 550 may transmit first anonymous ID PDⱼ of the UAV, ID S of the server, cipher text eⱼ and first value rⱼ to the server 530.

In operation S508, the server 530 may identify the ID of the UAV, the past first temporary authentication value and the current second temporary authentication value, by using the first anonymous ID of the UAV.

In operation S509, the server 530 may generate an encryption key and a MAC key between the UAV and the server, using the past first temporary authentication value or the current second temporary authentication value. In operation S511, the server 530 may decrypt the received cipher text eⱼ using the generated encryption key. In operation S512, the server 530 may authenticate received first value rⱼ by using the generated MAC key.

In operation S513, when the first value is authenticated, by using decrypted first anonymous ID PUᵢ of the user, the server 530 may identify user ID Uᵢ, past first temporary authentication value PUᵢ and current second temporary authentication value PUᵢ′.

In operation S514, the server 530 may generate an encryption key and a MAC key between the user and the server by using first temporary authentication value PUᵢ and second temporary authentication value PUᵢ′.

In operation S515, the server 530 may encrypt first anonymous ID PDⱼ of the UAV and random number value rdⱼ generated by the UAV based on Equation 31 by using the generated encryption key.

cᵢ=E_{ck}_{ᵢ}(PDⱼ∥rdⱼ) [Equation 31]

In operation S516, the server 530 may derive second value τᵢ by calculating cipher text cᵢ based on Equation 32 by using MAC key mkᵢ together with server ID S and the user's first anonymous ID PUᵢ.

τᵢ=Macₘₖ_{ᵢ}(S∥PUᵢ∥cᵢ) [Equation 32]

In operation S517, the server 530 may transmit server ID S, the user's first anonymous ID PUᵢ, cipher text cᵢ and second value τᵢ to the user terminal 510.

In operation S518, the user terminal 510 may decrypt received cipher text cᵢ by using the encryption key. In operation S519, the user terminal 510 may authenticate received second value τᵢ by using the MAC key. In operation S521, the user terminal 510 may generate random number value ruᵢ, second anonymous ID PUᵢ′ of the user, and second temporary authentication value αᵢ′.

In operation S522, the user terminal 510 may encrypt random number values ruᵢ and rdⱼ, the users second anonymous ID PUᵢ′, and second temporary authentication value αᵢ′ based on Equation 33.

dᵢ=E_{ck}_{ᵢ}(PUᵢ′∥αᵢ′∥ruᵢ∥rdⱼ) [Equation 33]

In operation S523, the user terminal 510 may derive third value eᵢ by calculating cipher text dᵢ based on Equation 34 by using MAC key mkᵢ together with the user's first anonymous ID PUᵢ and server ID S.

eᵢ=Macₘₖ_{ᵢ}(PUᵢ∥S∥dᵢ) [Equation 34]

In operation S524, the user terminal 510 may transmit the user's first anonymous ID PUᵢ, server ID S, cipher text dᵢ and third value eᵢ to the server 530.

In operation S525, the server 530 may decrypt the received cipher text by using the user's encryption key. In operation S526, the server 530 may authenticate the received third value by using the MAC key.

In operation S527, the server 530 may encrypt the user's first anonymous ID PUᵢ and random number values ruᵢ and rdⱼ based on Equation 35 by using the encryption key of the UAV.

dⱼ=Eₑₖ_{ⱼ}(PUᵢ∥ruᵢ∥rdⱼ) [Equation 35]

In operation S528, the server 530 may derive fourth value eⱼ by calculating cipher text dⱼ based on Equation 36 using the MAC key together with the server ID and the first anonymous ID of the UAV.

eⱼ=Macₘₖ_{ⱼ}(S∥PDⱼ∥dⱼ) [Equation 36]

In operation S529, the server 530 may store the user's ID Uᵢ, the user's past first anonymous ID PUᵢ, the user's current second anonymous ID PUᵢ′, the user's past first temporary authentication value αᵢ and the user's current second temporary authentication value αᵢ′ as in Equation 37. Further, the server 530 may store ID Dⱼ of the UAV, past first anonymous ID PDⱼ of the UAV, second anonymous ID PDⱼ′ of the UAV, first temporary authentication value βᵢ of the UAV, and current second temporary authentication value βᵢ′ of the UAV as in Equation 37.

Store (Uᵢ,PUᵢ^{o}=PUᵢ,PUᵢⁿ=PUᵢ′,

αᵢ^{o}=αᵢ,αᵢⁿ=αᵢ′)

and (Dⱼ,PDⱼ^{o}=PDⱼ,PDₙⁿ=PDⱼ′,

βⱼ^{o}=βⱼ,βⱼⁿ=βⱼ′) [Equation 37]

In operation S531, the server 530 may transmit first anonymous ID PDⱼ of the UAV, server ID S, cipher text dⱼ and fourth value eⱼ to the UAV 550.

In operation S532, the UAV 550 may decrypt the received cipher text using the encryption key of the UAV. In operation S533, the UAV 550 may authenticate the received fourth value by using the MAC key.

In operation S534, the UAV 550 may generate a MAC key based on Equation 38 by using first anonymous ID PDⱼ and random number value rdⱼ of the UAV, and first anonymous ID PUᵢ and random number value ruᵢ of the user, and may generate a session key based on Equation 39.

$${mk}_{i , j} = H ( {PU}_{i} ‖ {PD}_{j} ‖ {ru}_{i} ‖ {rd}_{j} ‖ 0 ) \qquad [ Equation 38 ]$$

$${sk}_{i , j} = H ( {PU}_{i} ‖ {PD}_{j} ‖ {ru}_{i} ‖ r {d}_{j} ‖ 1 ) \qquad [ Equation 39 ]$$

In operation S535, the UAV 550 may derive fifth value δ_{i,j} by calculation based on Equation 40 by using the MAC key together with the user's first anonymous ID PUᵢ and the UAV's first anonymous ID PDᵢ.

δ_{i,j}=Macₘₖ_{_{i,j}}(PUᵢ∥PDⱼ∥0) [Equation 40]

The UAV 550 may store ID Dⱼ of the UAV, second anonymous ID PDⱼ′ of the UAV, and second temporary authentication value βⱼ′. In operation S536, the UAV 550 may transmit the user's first anonymous ID PUᵢ, first anonymous ID PDⱼ of the UAV and fifth value (δ_{i,j}) to the user terminal 510.

In operation S537, the user terminal 510 may generate a MAC key based on Equation 41 by using the first anonymous ID of the UAV, the first anonymous ID of the user and random number values, and may generate a session key based on Equation 42. In this case, the MAC key and the session key generated based on Equation 41 and Equation 42 may be the same as the MAC key and the session key generated based on Equation 38 and Equation 39. Therefore, the user terminal and the UAV may share the same MAC key and the same session key.

$${mk}_{i , j} = H ( {PU}_{i} ‖ {PD}_{j} ‖ {ru}_{i} ‖ r {d}_{j} ‖ 0 ) \qquad [ Equation 41 ]$$

$${sk}_{i , j} = H ( {PU}_{i} ‖ {PD}_{j} ‖ {ru}_{i} ‖ r {d}_{j} ‖ 1 ) \qquad [ Equation 42 ]$$

In operation S538, the user terminal 510 may authenticate the fifth value by using the MAC key, and thereafter, the user's second anonymous ID and the second temporary authentication value may be encrypted based on Equation 43 and then store.

vᵢ=E_{H(U}_{ᵢ}_{∥pw}_{ᵢ}₎(PUᵢ′∥αᵢ′) [Equation 43]

According to the user's request, the key agreement protocol may be performed through operations with regard to FIGS. 2, 3, 5A and 5B described above.

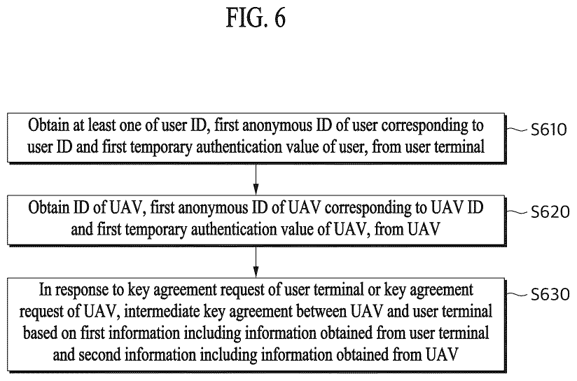

FIG. 6 is a flowchart illustrating a method of operating an electronic device according to an example embodiment. For reference, the electronic device may be a device included in the aforementioned server, and the above description may also be applied to FIG. 6.

Referring to FIG. 6, through the process of registering the user described in FIG. 2 to the server, in operation S610, the electronic device may obtain at least one of the user's ID, the user's first anonymous ID corresponding to the user's ID and the user's first temporary authentication value from the user terminal.

Through the process of registering the UAV described in FIG. 3 to the server, in operation S620, the electronic device may obtain from the UAV at least one of an ID of the UAV, a first anonymous ID of the UAV corresponding to the ID of the UAV, and a first temporary authentication value of the UAV.

As described with regard to FIGS. 4A, 4B, 5A and 5B, the electronic device may intermediate a key agreement procedure between the user terminal and the UAV.

In operation S630, in response to a key agreement request of the user terminal or a key agreement request of the UAV, the electronic device may intermediate the key agreement between the UAV and the user terminal based on first information including information obtained from the user terminal and second information including information obtained from the UAV.

In this case, the key agreement request of the UAV may correspond to transmitting the first anonymous ID of the UAV from the UAV to the user terminal as described with regard to FIGS. 4A and 4B. Further, the key agreement request of the user terminal may correspond to transmitting the first anonymous ID of the user terminal from the user terminal to the UAV as illustrated in FIGS. 5A and 5B.

Further, according to the key agreement between the UAV and the user terminal, the user terminal and the UAV may share the same MAC key and the same session key.

In this case, the first anonymous ID and the first temporary authentication value of the user may be randomly generated regardless of the user's ID, and the first anonymous ID and the first temporary authentication value of the UAV may also be randomly generated regardless of the ID of the UAV.

Further, the first information may include at least one of the user's ID, the user's first anonymous ID, the user's first temporary authentication value, a second anonymous ID different from the user's first anonymous ID, a second temporary authentication value different from the user's first temporary authentication value, and a random number value of the user.

Further, the second information may include at least one of the ID of the UAV, the first anonymous ID of the UAV, the first temporary authentication value of the UAV, a second anonymous ID different from the first anonymous ID of the UAV, a second temporary authentication value different from the first temporary authentication value of the UAV, and a random number value of the UAV.

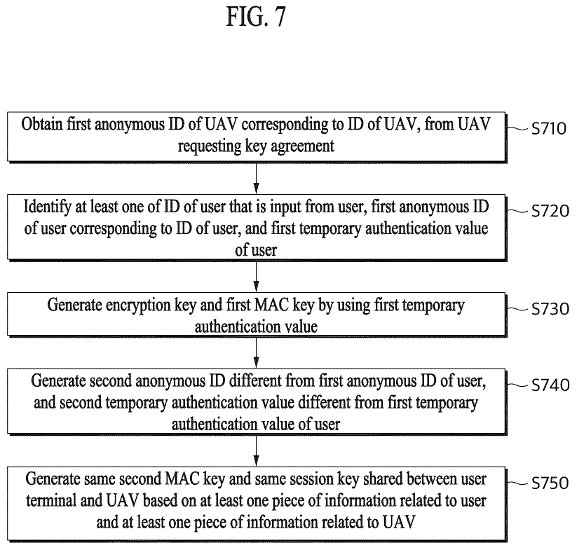

FIG. 7 is a flowchart illustrating a method of operating a user terminal according to an example embodiment. The contents described with regard to FIGS. 4A and 4B may be applied to FIG. 7, and for details, please refer to the above description.

Referring to FIG. 7, in operation S710, the user terminal may obtain a first anonymous ID of a UAV corresponding to an ID of the UAV from the UAV requesting key agreement. In operation S720, the user terminal may identify at least one of the user's ID that is input from the user, the user's first anonymous ID corresponding to the user's ID, and the user's first temporary authentication value. In operation S730, the user terminal may generate an encryption key and a first MAC key by using the first temporary authentication value. In operation S740, the user terminal may generate a second anonymous ID different from the first anonymous ID of the user and a second temporary authentication value different from the first temporary authentication value of the user. In operation S750, the user terminal may generate the same second MAC key and the same session key shared between the user terminal and the UAV based on at least one piece of information related to the user and at least one piece of information related to the UAV.

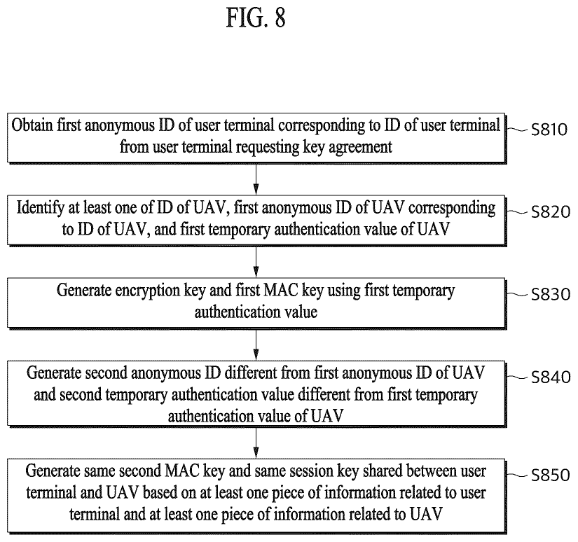

FIG. 8 is a flowchart illustrating a method of operating a UAV according to an example embodiment. The contents described with regard to FIGS. 5A and 5B may be applied to FIG. 8, and for details, please refer to the above description.

Referring to FIG. 8, in operation S810, the UAV may obtain a first anonymous ID of a user terminal corresponding to an ID of the user terminal from the user terminal requesting key agreement. In operation S820, the UAV may identify at least one of an ID of the UAV, a first anonymous ID of the UAV corresponding to the ID of the UAV, and a first temporary authentication value of the UAV. In operation S830, the UAV may generate an encryption key and a first MAC key by using the first temporary authentication value. In operation S840, the UAV may generate a second anonymous ID different from the first anonymous ID of the UAV and a second temporary authentication value different from the first temporary authentication value of the UAV. In operation S850, the UAV may generate the same second MAC key and the same session key shared between the user terminal and the UAV based on at least one piece of information related to the user terminal and at least one piece of information related to the UAV.

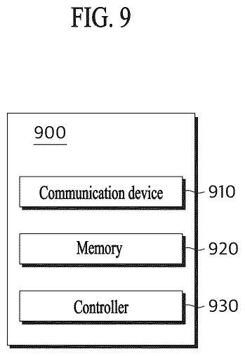

FIG. 9 is a block diagram of an electronic device according to an example embodiment.

According to the example embodiment, an electronic device 900 may include a communication device 910, a memory 920 and a controller 930. FIG. 9 illustrates only components related to the example embodiment of the electronic device 900. Therefore, it may be understood by those of ordinary skill in the art related to the present disclosure that other general-purpose components may be further included in addition to the components illustrated in FIG. 9. With regard to the electronic device 900, the above-described contents may be applied and thus, a description of overlapping content will be omitted.

The communication device 910 may be a device that performs wired/wireless communication, and the memory 920 may be a device that stores at least one instruction. The controller 930 may control the overall operation of the electronic device 900 and process data and signals. The controller 930 may be composed of at least one hardware unit. Further, the controller 930 may operate by one or more software modules generated by executing program codes stored in the memory 920. The controller 930 may execute a program code stored in the memory 920 to control the overall operation of the electronic device 900 and process data and signals.

The controller 930 may obtain at least one of an ID of a user, a first anonymous ID of the user corresponding to the ID of the user and a first temporary authentication value of the user, from a user terminal, obtain at least one of an ID of an unmanned aerial vehicle (UAV), a first anonymous ID of the UAV corresponding to the ID of the UAV and a first temporary authentication value of the UAV, from the UAV, and in response to a key agreement request of the user terminal or a key agreement request of the UAV, intermediate key agreement between the UAV and the user terminal based on information related to the user terminal and information related to the UAV.

The above-described electronic device or terminal may include a controller, a memory (e.g., a non-transitory memory) for storing and executing program data, a permanent storage such as a disk drive, a communication port for communicating with an external device, and a user interface device. In addition to this, it can be understood by those of ordinary skill in the art related to the present disclosure that other general-purpose components may be further included. The controller may control the overall operation of the electronic device and process data and signals. The controller may be configured with at least one hardware unit. Further, a controller may be operated by one or more software modules that are generated by executing a program code stored in a memory. The controller may execute program code stored in the memory to control the overall operation of the electronic device and process data and signals. Methods implemented as software modules or algorithms may be stored in a computer-readable recording medium as computer-readable codes or program instructions executable on the controller. Here, the computer-readable recording medium includes a magnetic storage medium (e.g., ROMs, RAMs, floppy disks and hard disks) and an optically readable medium (e.g., CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and look-up table, that may execute various functions by the control of one or more microcontrollers or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more controllers. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a controller or the like.

The above-described example embodiments are merely examples, and other embodiments may be implemented within the scope of the claims to be described later. It will be apparent to those skilled in the art that various modifications and variations can be made in the electronic device for providing bidirectional key agreement protocol and operating method thereof of the present invention without departing from the spirit or scope of the invention. Thus, it is intended that the present invention cover the modifications and variations of this invention provided they come within the scope of the appended claims and their equivalents.

What is claimed is:

1. A method of operating an electronic device, comprising:
obtaining at least one of an ID of a user, a first anonymous ID of the user corresponding to the ID of the user and a first temporary authentication value of the user, from a user terminal;
obtaining at least one of an ID of an unmanned aerial vehicle (UAV), a first anonymous ID of the UAV corresponding to the ID of the UAV and a first temporary authentication value of the UAV, from the UAV; and
in response to a key agreement request of the user terminal or a key agreement request of the UAV, intermediating key agreement between the UAV and the user terminal based on first information including information obtained from the user terminal and second information including information obtained from the UAV.

2. The method of claim 1, wherein the key agreement request of the UAV corresponds to transmitting the first anonymous ID of the UAV from the UAV to the user terminal, and
wherein the key agreement request of the user terminal corresponds to transmitting the first anonymous ID of the user terminal from the user terminal to the UAV.

3. The method of claim 2, wherein the intermediating key agreement between the UAV and the user terminal, in response to the key agreement request of the user terminal or the key agreement request of the UAV, comprises sharing a same message authentication code (MAC) key and a same session key between the user terminal and the UAV, based on the first information and the second information.

4. The method of claim 3, wherein the first anonymous ID of the user and the first temporary authentication value of the user are randomly generated regardless of the ID of the user.

5. The method of claim 4, wherein the first information comprises at least one of the ID of the user, the first anonymous ID of the user, the first temporary authentication value of the user, a second anonymous ID different from the first anonymous ID of the user, a second temporary authentication value different from the first temporary authentication value of the user and a random number value of the user.

6. The method of claim 1, wherein the first anonymous ID of the UAV and the first temporary authentication value of the UAV are randomly generated regardless of the ID of the UAV.

7. The method of claim 6, wherein the second information comprises at least one of the ID of the UAV, the first anonymous ID of the UAV, the first temporary authentication value of the UAV, a second anonymous ID different from the first anonymous ID of the UAV, a second temporary authentication value different from the first temporary authentication value of the UAV and a random number value of the UAV.

8. A method of operating a user terminal, comprising:
from a UAV requesting key agreement, obtaining a first anonymous ID of the UAV corresponding an ID of the UAV;
identifying at least one of an ID of a user that is input from the user, a first anonymous ID of the user corresponding to the ID of the user, and a first temporary authentication value of the user;
generating an encryption key and a first MAC key by using the first temporary authentication value;
generating a second anonymous ID different from the first anonymous ID of the user and a second temporary authentication value different from the first temporary authentication value of the user; and
generating a same second MAC key and a same session key shared between the user terminal and the UAV based on at least one piece of information related to the user and at least one piece of information related to the UAV.

9. A method of operating a UAV, comprising:
obtaining a first anonymous ID of a user terminal corresponding to an ID of the user terminal from the user terminal requesting key agreement;
identifying at least one of an ID of the UAV, a first anonymous ID of the UAV corresponding to the ID of the UAV, and a first temporary authentication value of the UAV;
generating an encryption key and a first MAC key using the first temporary authentication value;
generating a second anonymous ID different from the first anonymous ID of the UAV and a second temporary authentication value different from the first temporary authentication value of the UAV; and
generating a same second MAC key and a same session key shared between the user terminal and the UAV based on at least one piece of information related to the user terminal and at least one piece of information related to the UAV.

10. An electronic device comprising:
a communication device;
a memory for storing at least one instruction; and
a controller configured to:
obtain at least one of an ID of a user, a first anonymous ID of the user corresponding to the ID of the user and a first temporary authentication value of the user, from a user terminal;
obtain at least one of an ID of an unmanned aerial vehicle (UAV), a first anonymous ID of the UAV corresponding to the ID of the UAV and a first temporary authentication value of the UAV, from the UAV; and
in response to a key agreement request of the user terminal or a key agreement request of the UAV, intermediate key agreement between the UAV and the user terminal based on first information including information obtained from the user terminal and second information including information obtained from the UAV.
